(19) United States
(12) Patent Application Publication
(10) Pub. No.: US 2009/0128848 A1
(43) Pub. Date: May 21, 2009

(54) IMAGE FORMING APPARATUS, IMAGE SCANNING APPARATUS, AND REMOTE DIAGNOSIS METHOD FOR IMAGE FORMING APPARATUS

(75) Inventor: Yoshikatsu Kamisuwa, Tokyo (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/269,665

(22) Filed: Nov. 12, 2008

Related U.S. Application Data
(60) Provisional application No. 60/988,338, filed on Nov. 15, 2007.

(51) Int. Cl. G06K 15/02

(52) U.S. Cl. 358/1.15; 358/1.16

(57) ABSTRACT

An image forming apparatus sets setting information for forming an image, detects, using a media sensor, characteristic information of a recording medium on which an image is formed according to setting by the setting information, forms an image on the recording medium, the characteristic information of which is detected by the media sensor, on the basis of the setting information, stores, as log data, the setting information for forming an image on the recording medium and the characteristic information of the recording medium detected by the media sensor, and transmits the log data to an image diagnosis apparatus that diagnoses a state of image forming processing in the image forming apparatus.

### CROSS-REFERENCE TO RELATED APPLICATION

This application claims the benefit of U.S. Provisional Application No. 60/988,338, filed Nov. 15, 2007.

### TECHNICAL FIELD

The present invention relates to a remote diagnosis system that diagnoses, in a remote location, deficiencies, deterioration in images, and the like in image forming apparatuses such as a digital multi-function peripheral.

### BACKGROUND

Conventionally, among image forming apparatuses such as a digital multi-function peripheral, there is an image forming apparatus having a function of undergoing diagnosis for maintenance in a service center in a remote location (remote diagnosis). The remote diagnosis is not limited to, for example, diagnosis for only various deficiencies in a digital multi-function peripheral that needs repairing or replacement of components. For example, there is also a system that diagnoses, as a kind of the remote diagnosis, a quality of an image formed on a sheet by the digital multi-function peripheral (an image quality) and the like. With such a function of diagnosing an image, a cause of deterioration in the image quality and the like are diagnosed.

Conventionally, with an image diagnosis function in a remote maintenance system, a digital multi-function peripheral scans, using a scanner, an image desired to be diagnosed and transmits scanned image data to a service center. The service center diagnoses the image on the basis of the image data received from the digital multi-function peripheral. JP-A-2006-126252 discloses an image forming apparatus that transmits setting information of a printer together with image data as data for image diagnosis. However, only the image data and the setting information are often insufficient for diagnosing in detail a cause of deterioration in a quality of an image printed on a sheet.

### SUMMARY

According to an aspect of the present invention, there is provided an image forming apparatus that can undergo highly accurate remote diagnosis for an image, an image scanning apparatus, and a remote diagnosis method for the image forming apparatus.

The image forming apparatus according to the aspect of the invention includes: a setting unit that sets setting information for forming an image on a recording medium; a printer that forms an image on the recording medium on the basis of setting contents set by the setting unit; a media sensor that detects characteristic information of the recording medium on which the printer forms an image; a storing unit that stores, if the printer forms an image on the recording medium, as log data, the setting information set by the setting unit and the characteristic information of the recording medium detected by the media sensor; and an interface that transmits the log data stored in the storing unit to an image diagnosis apparatus that diagnoses a state of image forming processing in the image forming apparatus.

According to another aspect of the present invention, there is provided an image scanning apparatus including: a scanner that scans an image formed on a recording medium by a printer and converts the image into image data; a media sensor that detects characteristic information of the recording medium; and a communication interface that transmits the image data scanned from the recording medium by the scanner and the characteristic information of the recording medium detected by the media sensor to an image diagnosis apparatus that diagnoses the image formed on the recording medium by the printer.

According to still another aspect of the present invention, there is provided a remote diagnosis method for an image forming apparatus, the remote diagnosis method including: setting information for forming an image; detecting, using a media sensor, characteristic information of a recording medium on which an image is formed according to setting by the setting information; forming an image on the recording medium, the characteristic information of which is detected by the media sensor, on the basis of the setting information; storing, as log data, the setting information for forming an image on the recording medium and the characteristic information of the recording medium detected by the media sensor; and transmitting the log data to an image diagnosis apparatus that diagnoses a state of image forming processing in the image forming apparatus.

Additional objects and advantages of the invention will be set forth in the description which follows, and in part will be obvious from the description, or may be learned by practice of the invention. The objects and advantages of the invention may be realized and obtained by means of instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram of a configuration example of a network system including a digital multi-function peripheral;

FIG. 2 is a perspective view of an external configuration example of the digital multi-function peripheral;

FIG. 3 is a schematic diagram of a configuration example of the digital multi-function peripheral;

FIG. 4 is a block diagram for explaining a configuration example of a control system in the digital multi-function peripheral;

FIG. 5 is a diagram of a configuration example of a media sensor;

FIG. 6 is a diagram of a structure example of a log database;

FIG. 7 is a diagram of a structure example of a first management table;

FIG. 8 is a diagram of a structure example of a second management table; and

FIG. 9 is a flowchart for explaining a processing procedure in a digital multi-function peripheral that undergoes remote diagnosis for an image.

### DETAILED DESCRIPTION

An embodiment of the present invention is explained below with reference to the accompanying drawings.

First, a configuration of a network system including a digital multi-function peripheral 1 as an example of an image forming apparatus is explained.

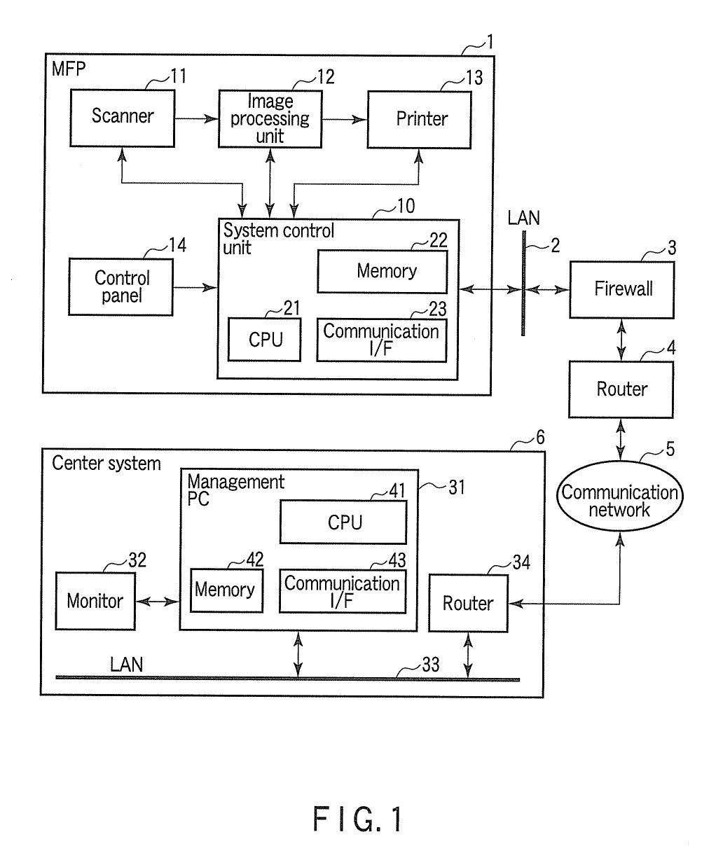

FIG. 1 is a diagram of a configuration example of a network system.

The network system shown in FIG. 1 is a system that provides the digital multi-function peripheral (MFP) 1 as an example of an image forming apparatus with services such as maintenance. The network system includes, as shown in FIG. 1, the digital multi-function peripheral 1, a LAN 2, a firewall 3, a router 4, a communication network 5, and a center system 6.

The digital multi-function peripheral 1, the LAN 2, the firewall 3, and the router 4 configure a network system for a user who uses the digital multi-function peripheral 1. In other words, the digital multi-function peripheral 1 is connected to the communication network 5 via the LAN 2, the firewall 3, and the router 4. The communication network 5 is, for example, a wide area network system that uses a public line. The center system 6 is also connected to the communication network 5. In other words, the digital multi-function peripheral 1 and the center system 6 communicate with each other via the communication network 5. The center system 6 is a system for providing the digital multi-function peripheral 1 with services such as maintenance. For example, the center system 6 performs, for example, diagnosis of deficiencies that occur in the digital multi-function peripheral 1.

The digital multi-function peripheral 1 includes a system control unit 10, a scanner 11, an image processing unit 12, a printer 13, and a control panel 14. The system control unit 10 manages the control of the entire digital multi-function peripheral 1. In the configuration example shown in FIG. 1, the system control unit 10 includes a CPU 21, a memory unit 22, and a communication interface (I/F) 23.

The CPU 21 performs comprehensive control in the digital multi-function peripheral 1, data processing, and the like.

The memory unit 22 includes a read only memory (ROM), a random access memory (RAM), a nonvolatile memory, an image memory, and a hard disk drive (HDD). The ROM stores control programs, control data, and the like. The RAM stores work data and the like. The nonvolatile memory is a rewritable nonvolatile memory. The nonvolatile memory stores control programs, a control data, and the like. The image memory is a memory that stores processing-object image data. The HDD is a large capacity storage device.

The CPU 21 realizes various functions by using the memory unit 22. The CPU 21 realizes the various functions by executing the control programs stored in the ROM, the nonvolatile memory, or the HDD using the RAM, the image memory, or the HDD.

The communication I/F 23 is an interface for performing communication via the LAN 2. The digital multi-function peripheral 1 communicates with the center system 6 using the communication I/F 23 via the LAN 2, the firewall 3, the router 4, and the communication network 5.

The LAN 2 is, for example, a communication line in a network system built by a user who uses the digital multi-function peripheral 1. The firewall 3 maintains security between the LAN 2 and the communication network 5. For example, the firewall 3 prevents illegal access to the LAN 2 and prevents data from illegally flowing out from the LAN 2. The router 4 controls the connection to the communication network 5 via the LAN 2 and the firewall 3.

The center system 6 includes a management PC 31, a monitor 32, a LAN 33, and a router 34. The management PC 31 includes a CPU 41, a memory 42, and a communication interface (I/F) 43.

The CPU 41 manages the control in the management PC 31. The memory 42 includes a read only memory (ROM), a random access memory (RAM), a nonvolatile memory, an image memory, and a hard disk drive (HDD). The CPU 41 realizes various functions by executing control programs stored in the memory 42 using the memory 42.

The communication I/F 43 is an interface for performing communication via the LAN 33. The management PC 31 communicates with the digital multi-function peripheral 1 using the communication I/F 43 via the LAN 33, the router 34, the communication network 5, the router 4, the firewall 3, and the LAN 2.

The monitor 32 is connected to the management PC 31. The monitor 32 displays various screens on the basis of the control by the management PC 31. The LAN 33 is, for example, a communication line provided in a service center in which the center system 6 is built. The router 34 controls the connection to the communication network 5 via the LAN 33.

A configuration of the digital multi-function peripheral 1 is explained.

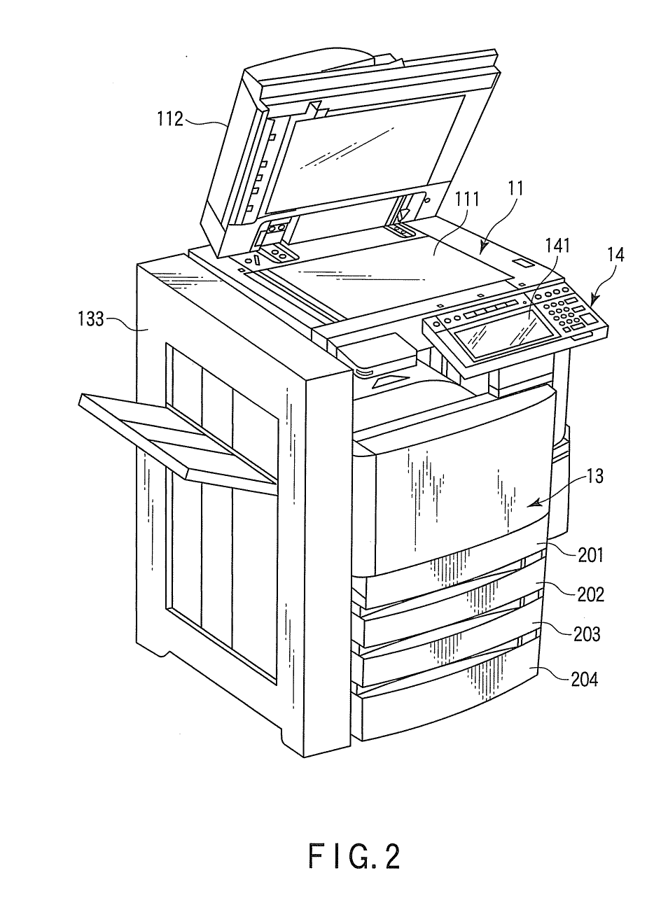

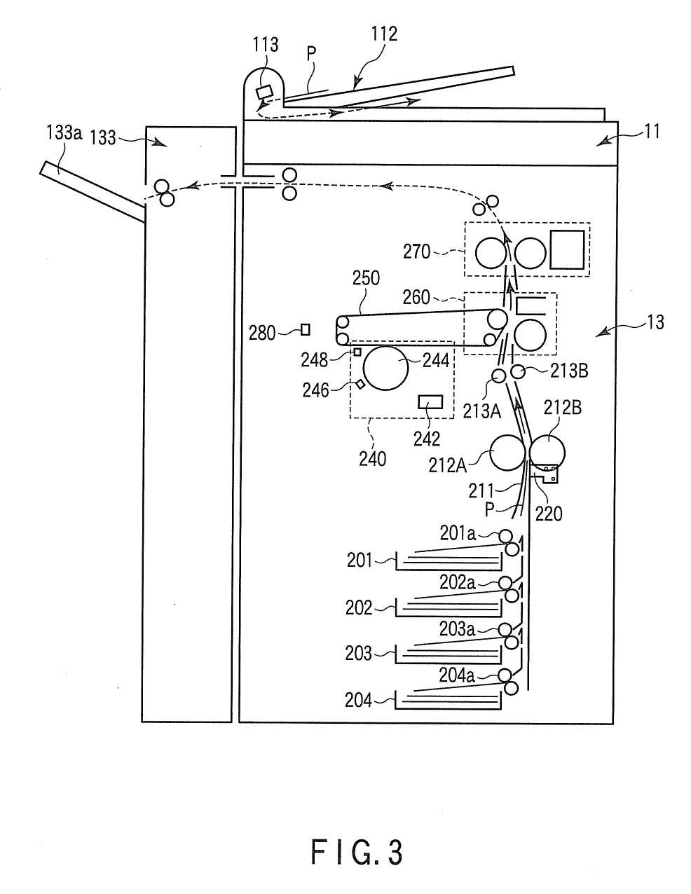

FIG. 2 is a perspective view of an external configuration example of the digital multi-function peripheral 1. FIG. 3 is a schematic diagram of a configuration example in the digital multi-function peripheral 1.

As shown in FIG. 2, a main body of the digital multi-function peripheral 1 includes units such as the scanner 11, the printer 13, and the control panel 14. Further, a processing unit having the system control unit 10, the image processing unit 12, and the like explained above is incorporated in the main body of the digital multi-function peripheral 1.

The scanner 11 is set in an upper part of the main body of the digital multi-function peripheral 1. The scanner 11 is a device that optically scans an image of an original. The scanner 11 includes a not-shown CCD line sensor. The CCD line sensor scans an image for one line in a main scanning direction in the original. The scanner 11 scans an image of the entire original by causing the CCD line sensor to perform scanning in a sub-scanning direction of the original. For example, the scanner 11 scans the image of the entire original by causing the CCD line sensor to perform scanning in the sub-scanning direction of the original placed on an original stand 111.

In the configuration example shown in FIGS. 2 and 3, the scanner 11 has an auto document feeder (ADF) 112. The ADF 112 is arranged in an upper part of the main body of the digital multi-function peripheral 1. The ADF 112 conveys sheet-like originals one by one. The scanner 11 scans an image of the original conveyed by the ADF 112. The ADF 112 is set such that the entire ADF 112 can be opened and closed in the upper part of the digital multi-function peripheral 1. The ADF 112 functions as, in a closed state, a cover for an original placed on the original stand 111 as well. A media sensor 113 is provided in the ADF 112. The media sensor 113 is a sensor that detects characteristic information indicating characteristics of an original to be conveyed. For example, the media sensor 113 detects information indicating the thickness, a degree of glossiness, a material, and the like of the original.

The control panel 14 is set in a front part on an upper surface of the main body of the digital multi-function peripheral 1. The control panel 14 displays guidance for the user and receives an instruction input from the user. For example, the user instructs a copy condition or copy start using the control panel 14.

The control panel 14 includes various operation keys and various display devices. For example, a touch panel display 141 as a display device incorporating a touch panel is provided in the control panel 14. In displaying the various kinds of information or requesting input, the user touches an icon indicating a desired instruction content among icons displayed on the touch panel display 141 while checking information displayed on the touch panel display 141.

The printer 13 includes a paper feeding mechanism, a print mechanism, and a post-processing mechanism. The paper feeding mechanism stores sheets as image forming media. The paper feeding mechanism feeds the sheets stored therein to the print mechanism one by one. The print mechanism forms an image on the sheet fed by the paper feeding mechanism. For example, as the print mechanism, various print systems such as the electrophotographic system, the ink-jet system, and the thermal transfer system can be applied. In this embodiment, it is assumed that the electrophotographic system is applied as the print mechanism. The post-processing mechanism processes the sheets on which the image is printed by the print mechanism. For example, the post-processing mechanism applies stapling, hole-punching, or the like to the sheets subjected to print processing. In the example of the digital multi-function peripheral shown in FIGS. 2 and 3, a finisher 133 is set as the post-processing mechanism.

The printer 13 includes, as shown in FIGS. 2 and 3, paper feeding cassettes 201, 202, 203, and 204. The paper feeding cassettes 201, 202, 203, and 204 store sheets to be subjected to the printing by the print mechanism. For example, the paper feeding cassettes 201, 202, 203, and 204 can be attached to and detached from a lower part of the main body of the digital multi-function peripheral 1. The paper feeding cassettes 201, 202, 203, and 204 store various sheets set by the user. Usually, each of the paper feeding cassettes 201, 202, 203, and 204 stores sheets of the same kind. In this case, a paper feeding cassette is selected to select a kind of sheets.

Paper feeding rollers 201a, 202a, 203a, and 204a are provided in the paper feeding cassettes 201, 202, 203, and 204, respectively. Each of the paper feeding rollers 201a, 202a, 203a, and 204a extracts the sheets stored in each of the paper feeding cassettes 201, 202, 203, and 204 one by one. The extracted sheet is conveyed through a conveying path 211 by conveying rollers 212 (212A and 212B) and the like. The sheet is conveyed to registration rollers 213 (213A and 213B) through the conveying path 211.

The registration rollers 213 (213A and 213B) are a pair of rollers provided before the print mechanism. The registration rollers 213 convey the sheet, which is conveyed through conveying path 211, to a developing and transferring unit serving as the print mechanism at desired timing.

A media sensor 220 is provided on the conveying path 211. The media sensor 220 is set on, for example, the conveying path 211 between the paper feeding rollers 201a, 202a, 203a, and 204a and the registration rollers 213 (213A and 213B). The media sensor 220 is a sensor that detects characteristic information indicating characteristics of the sheet to be conveyed. For example, the media sensor 220 detects information indicating the thickness, a degree of glossiness, and a material of the sheet. The media sensor 220 may have a configuration same as that of the media sensor 113 provided in the ADF 112.

The print mechanism includes an image generating unit 240, an intermediate transfer member 250, a developing and transferring unit 260, a fixing unit 270, and a temperature and humidity sensor 280.

The image generating unit 240 includes an exposing device 242 and a photoconductive drum 244. The image generating unit 240 includes a potential sensor 246 and a density sensor 248 as well. The potential sensor 246 is a sensor that detects the surface potential of the photoconductive drum 244. The density sensor 248 is a sensor that detects the density of a toner image formed on the photoconductive drum 244 or the intermediate transfer member 250. The surface of the photoconductive drum 244 is charged by a not-shown electrification charger. The exposing device 242 forms an electrostatic latent image on the photoconductive drum 244, the surface of which is charged. When a toner is supplied to the surface of the photoconductive drum 244, the electrostatic latent image on the photoconductive drum 244 is changed to a toner image. The photoconductive drum 244 transfers the toner image formed on the surface thereof onto the intermediate transfer member 250.

The intermediate transfer member 250 supplies the toner image, which is transferred from the photoconductive drum 244, to the developing and transferring unit 260. The developing and transferring unit 260 transfers the toner image, which is supplied by the intermediate transfer member 250, onto the sheet. The registration rollers 213 feed the sheet to the developing and transferring unit 260 to place the sheet in a position of the toner image formed on the intermediate transfer member 250. The developing and transferring unit 260 feeds the sheet, on which the toner image is transferred, to the fixing unit 270.

The fixing unit 270 includes a heater, a heat roller, and a press roller. The fixing unit 270 fixes the toner image on the sheet using the heat roller heated by the heater and the press roller. The fixing unit 270 heats the sheet, on which the toner image is transferred by the developing and transferring unit 260, in a pressed state. The sheet subjected to fixing processing by the fixing unit 270 is conveyed to the finisher 133.

The finisher 133 processes the sheet P on which the image is formed by the print mechanism. The finisher 133 has a paper discharge tray for accumulating the sheets on which the image is formed by the print mechanism. The finisher 133 may have a function of stapling or hole-punching the sheets P accumulated in the paper discharge tray as well.

The temperature and humidity sensor 280 is a sensor that detects a state in the printer 13. The temperature and humidity sensor 280 detects the temperature and the humidity in the printer 13. The temperature and humidity sensor 280 is set in, for example, a place in the printer 13 where the temperature and humidity sensor 280 is less easily affected by a local temperature rise due to the heater in the fixing unit 270, various motors, or the like.

A configuration of a control system in the digital multi-function peripheral 1 configured as explained above is explained.

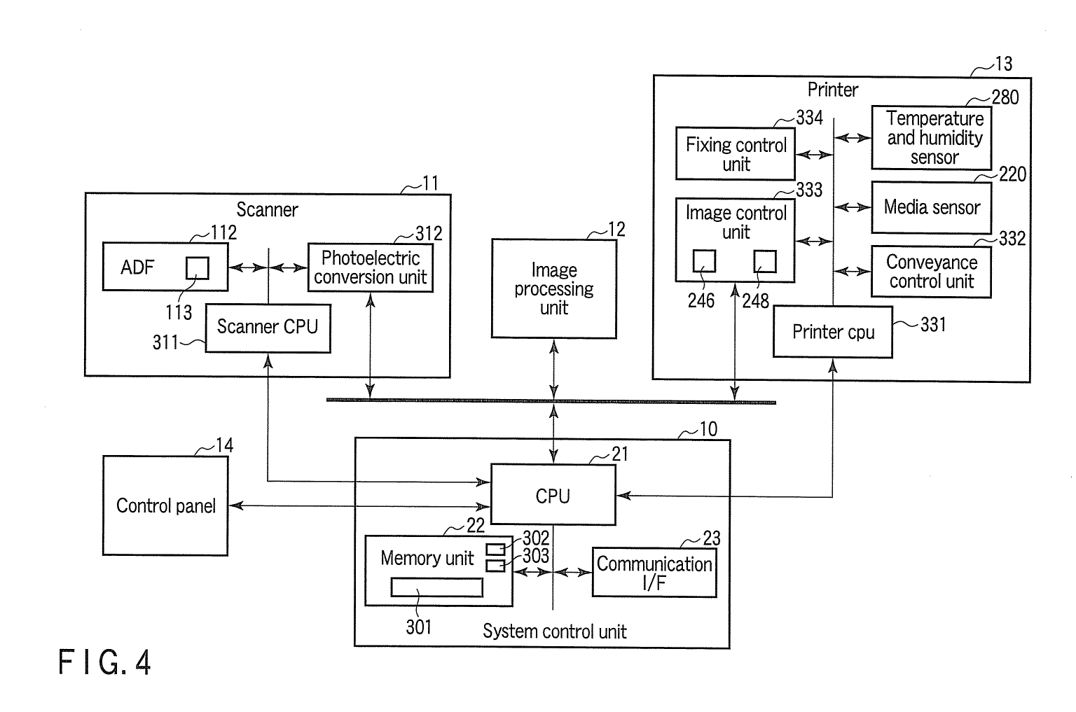

FIG. 4 is a block diagram for explaining a configuration example of the control system in the digital multi-function peripheral 1. As explained above, the digital multi-function peripheral 1 includes the system control unit 10, the scanner 11, the image processing unit 12, the printer 13, and the control panel 14.

As explained with reference to FIG. 1, the system control unit 10 includes the CPU 21, the memory unit 22, and the communication interface (I/F) 23.

The CPU 21 is connected to the scanner 11, the image processing unit 12, the printer 13, the control panel 14, and the like via a not-shown internal interface. The CPU 21 outputs operation instructions to and acquires various kinds of information from the scanner 11, the image processing unit 12, the printer 13, and the control panel 14 by performing two-way communication with the units. For example, the CPU 21 outputs setting information related to printing to the printer 13 and acquires information indicating a printing result from the printer 13. In this case, the information indicating a print processing result includes information detected by the respective sensors such as the media sensor 220, the potential sensor 246, the density sensor 248, and the temperature and humidity sensor 280.

The memory unit 22 has a log database 301, a first management table 302, a second management table 303, and the like. The log database 301, the first management table 302, and the second management tale 303 are used to store the information indicating a printing result acquired from the printer 13. The log database 301 accumulates information concerning printing applied to the sheets by the printer 13. One log data includes information concerning the printing performed once. For example, each log data includes, for example, setting information (information indicating a sheet size, a color mode, a duplex mode, presence or absence of electronic sort, and the like) of the printing and information detected by the sensors such as the media sensor 220, the temperature and humidity sensor 280, the potential sensor 246, and the density sensor 248 during the print processing.

The first and second management tables 302 and 303 are tables for statistically managing information concerning the printing executed by the printer 13. The first and second management tables 302 and 303 store statistic information obtained on the basis of information detected by the media sensor 220. For example, the first management table 302 stores, as statistic information, information concerning a state of the surface of the sheet (or a type of the sheet) subjected to the printing. The media sensor 220 detects a state of the surface of the sheet (a type of the sheet) on the basis of light reflected on the sheet. The second management table 303 stores, as statistic information, information concerning the thickness of the sheet subjected to the printing. The media sensor 220 detects the thickness of the sheet on the basis of light transmitted through the sheet.

The scanner 11 includes a scanner CPU 311, a photoelectric conversion unit 312, the ADF 112, and the media sensor 113.

The scanner CPU 311 manages the control in the scanner 11. The scanner CPU 311 realizes functions of controlling the respective units in the scanner 11 by executing control programs stored in a not-shown memory. As explained above, the ADF 112 is a device that conveys originals one by one. The ADF 112 conveys the original such that the surface of the original passes a predetermined main scanning position in the sub-scanning direction. The media sensor 113 detects characteristic information of the original conveyed by the ADF 112. The information detected by the media sensor 113 is supplied to the scanner CPU 311.

The photoelectric conversion unit 312 converts information obtained by optically scanning the surface of an original into image data. The photoelectric conversion unit 312 includes an exposing device and a line sensor. The exposing device exposes the surface of the original. The line sensor is configured by arranging photoelectric conversion elements, which convert light into an electronic signal, in one line in the main scanning direction. The line sensor scans image information for one line in the main scanning direction. Further, as a component for scanning an image of an original on the original stand 111, the photoelectric conversion unit 312 includes, for example, a driving unit that moves a carriage mounted with the exposing device and the line sensor in the sub-scanning direction.

The printer 13 includes, as components of the control system, a printer CPU 331, a conveyance control unit 332, an image control unit 333, a fixing control unit 334, the media sensor 220, the potential sensor 246, the density sensor 248, and the temperature and humidity sensor 280.

The printer CPU 331 manages the control in the printer 13. The printer CPU 331 also realizes functions of controlling the respective units in the printer 13 by executing control programs stored in a not-shown memory. The conveyance control unit 332 controls conveyance of the sheet in the printer 13.

The image control unit 333 controls processing for forming an image in the printer 13. The image control unit 333 controls the image generating unit 240 including the exposing device 242 and the photoconductive drum 244. The image control unit 333 supplies, every time the printing is applied to the sheet, detection results obtained by the potential sensor 246 and the density sensor 248 to the printer CPU 331. The fixing control unit 334 controls the fixing unit 270. For example, the fixing control unit 334 controls fixing temperature in the fixing unit 270. A detection result obtained by the media sensor 220 is supplied to the printer CPU 331 every time the printing is applied to the sheet. A detection result obtained by the temperature and humidity sensor 280 is also supplied to the printer CPU 331 every time the printing is applied to the sheet.

A configuration example of the media sensors 220 and 113 is explained below.

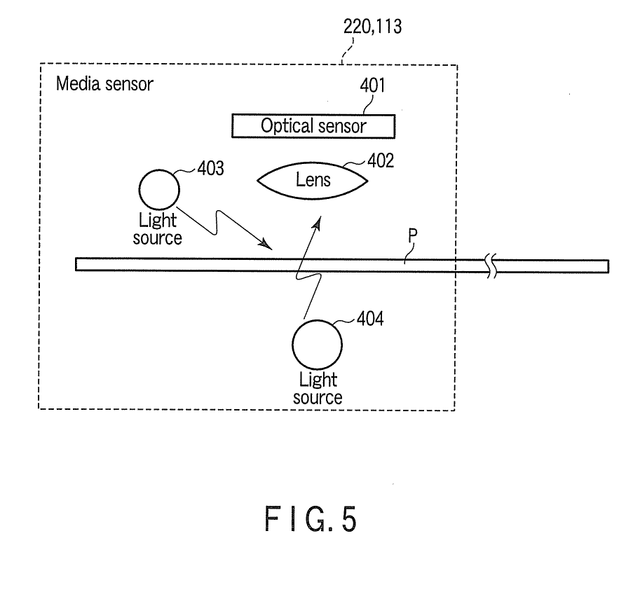

FIG. 5 is a diagram of the configuration example of the media sensors 220 and 113.

In the configuration example shown in FIG. 5, the media sensors 220 and 113 include an optical sensor 401, a lens 402, a reflection light source 403, and a transmission light source 404. The media sensor 220 is set on the conveying path 211 for the sheet. The media sensor 113 is set on a conveying path in the ADF. In the media sensor 220, the reflection light source 403 and the transmission light source 404 irradiate light for inspection on the sheet P as appropriate.

For example, in detecting a surface state of the sheet P, the reflection light source 403 irradiates light on the surface of the sheet. The light emitted from the reflection light source 403 is diffused and reflected according to the surface state of the sheet. The lens 402 condenses the light diffused and reflected on the surface of the sheet P. The optical sensor 401 converts the reflected light from the surface of the sheet P condensed by the lens 402 into an electric signal. The electric signal indicates a light amount of the reflected light that changes according to the surface state of the sheet P.

As the reflectivity of light on the surface of the sheet P is higher, the optical sensor 401 outputs an electric signal having a larger value. If a type of the sheet P can be distinguished according to the reflectivity of the light on the surface of the sheet P, a signal outputted from the optical sensor 401 is information indicating the type of the sheet P. As types of the sheet P, plain paper, coat paper, and an OHP sheet are assumed. The reflectivity of the light on the surface is larger in order of the OHP sheet, the coat paper, and the plain paper. Therefore, it is possible to set thresholds for distinguishing the plain paper, the coat paper, and the OHP sheet with respect to the electric signal outputted from the optical sensor 401. The media sensors 220 and 113 can detect, by comparing the thresholds and a value of the electric signal outputted from the optical sensor 401, which of the plain paper, the coat paper, and the OHP sheet the sheet P is.

In detecting the transmissivity of light in the sheet P (e.g., detecting the thickness of the sheet P), the transmission light source 404 irradiates light on the sheet P. The light emitted from the transmission light source 404 is transmitted through the sheet P according to the thickness of the sheet P. The light emitted from the transmission light source 404 is changed to transmissive light having a light amount corresponding to the thickness of the sheet P or the like and transmitted through the sheet P. The lens 402 condenses the light transmitted through the sheet P. The optical sensor 401 converts the light transmitted through the sheet P and condensed by the lens 402 into an electric signal. The electric signal indicates a light amount of the transmissive light that changes according to the thickness of the sheet P or the like.

As the thickness of the sheet P is smaller, the transmissivity of the light in the sheet P is high. Therefore, as the transmissivity of the light in the sheet P is higher, the optical sensor 401 outputs an electric signal having a larger value. If the thickness of the sheet P can be distinguished according to the transmissivity of the light in the sheet P, a signal outputted from the optical sensor 401 is information indicating a type of the sheet P. As types of the sheet P having different thicknesses, thin paper, plain paper, and thick paper are assumed. The transmissivity of the light in the sheet P is larger in order of the thin paper, the plain paper, and the thick paper. Therefore, it is possible to set thresholds for distinguishing the thin paper, the plain paper, and the thick paper with respect to the electric signal outputted from the optical sensor 401. The media sensors 220 and 113 can detect, by comparing the thresholds and a value of the electric signal outputted from the optical sensor 401, which of the thin paper, the plain paper, and the thick paper the sheet P is.

A structure example of the log database 301 is explained below.

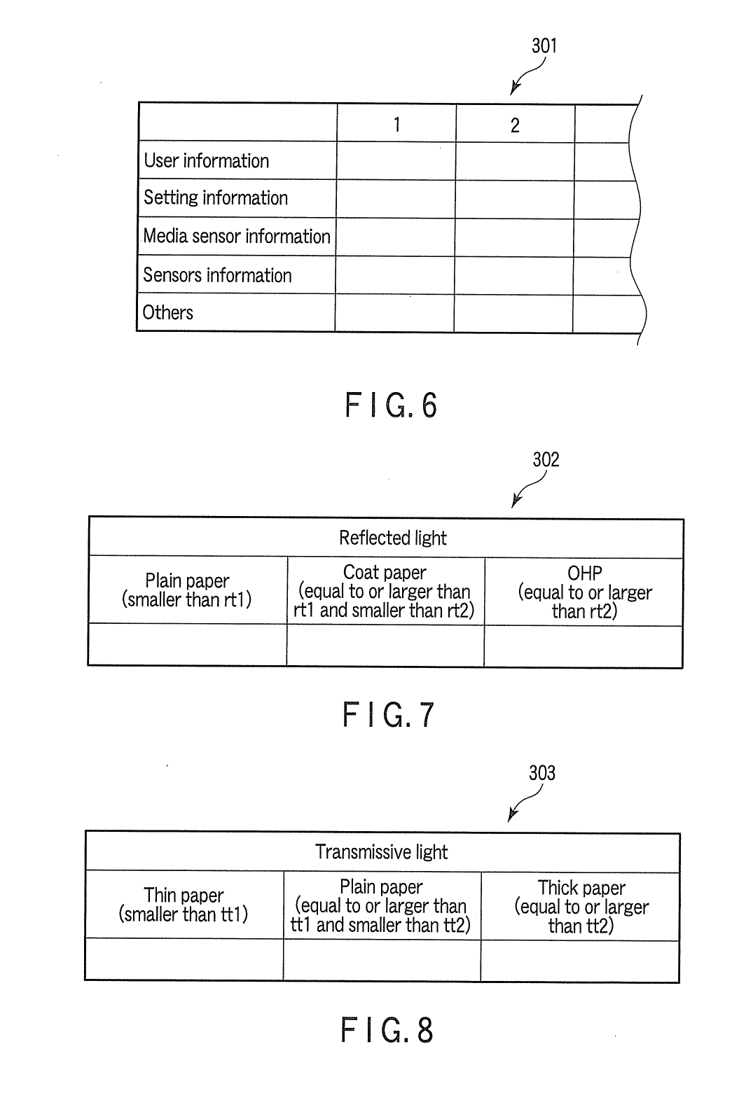

FIG. 6 is a diagram of the structure example of the log database 301. In the structure example shown in FIG. 6, log data is accumulated in the log database 301 every time the printing is applied to one sheet P. The log data shown in FIG. 6 includes user information, setting information, media sensor information, and sensors information.

In the user information, information indicating a user who executes the printing is stored. For example, if a user for whom authentication by user authentication processing is successful executes printing, information indicating the user specified by the user authentication processing is stored as user information. The user authentication processing can be carried out according to a combination of a user ID and a password. In this case, the system control unit 10 of the digital multi-function peripheral 1 judges propriety of user authentication according to whether a user ID and a password inputted by the user coincide with those of a registered person. However, a form of the user authentication is not limited to the user ID and the password. For example, as the user authentication, authentication performed by using a storage medium such as an IC card or authentication performed by using biological information of a user may be applied.

The setting information is information indicating various setting contents in the printing. For example, the setting information includes information indicating a size of the sheet P, information indicating whether a printed image is color or monochrome, information indicating whether printing on the sheet P is duplex printing or simplex printing, and information indicating presence or absence of electronic sort.

The media sensor information is information detected by the media sensor 220. In the configuration example shown in FIG. 5, the media sensor 220 detects, as information indicating characteristics of the sheet P, information indicating a light amount of reflected light from the surface of the sheet P and information indicating a light amount of transmissive light transmitted through the sheet P. Therefore, the media sensor information includes the information indicating a light amount of reflected light from the surface of the sheet P and the information indicating a light amount of transmissive light transmitted through the sheet P. However, the media sensor information may include information indicating a type of the sheet P distinguished according to the information indicating a light amount of reflected light from the surface of the sheet P. Further, the media sensor information may include information indicating the thickness of the sheet P distinguished according to the information indicating a light amount of transmissive light transmitted through the sheet P.

The sensors information is information detected by the various sensors in the printer 13. For example, in the configuration example shown in FIG. 3, besides the media sensor 220, the sensors such as the potential sensor 246, the density sensor 248, and the temperature and humidity sensor 280 are set in the printer 13. The sensors information includes, as information indicating a state or an environment during the printing, information detected by the sensors such as the potential sensor 246, the density sensor 248, and the temperature and humidity sensor 280. In this case, the sensors information indicates the surface potential of the photoconductive drum 244, the density of a toner, and temperature and humidity during the printing.

Structure examples of the first and second management tables 302 and 303 are explained below.

FIG. 7 is a diagram of the structure example of the first management table 302.

As explained above, the first management table 302 stores, as statistic information, information concerning a state of the surface of the sheet P (or a type of the sheet P) subjected to the printing in the digital multi-function peripheral 1. The media sensor 220 detects a state of the surface of the sheet P (a type of the sheet P) on the basis of reflected light from the sheet P. In the first management table 302 shown in FIG. 7, as types of the sheet P, plain paper, coat paper, and an OHP sheet are assumed.

In the first management table 302 shown in FIG. 7, counted numbers of the sheets P judged as the plain paper, the sheets P judged as the coat paper, and the sheets P judged as the OHP sheet are stored. Concerning the type of the sheet P, the sheet P is judged as the plain paper if a value of a signal detected by the media sensor 220 from reflected light from the sheet P is smaller than a threshold Rt1. The sheet P is judged as the coat paper if the value is equal to or larger than the threshold Rt1 and smaller than a threshold Rt2. The sheet P is judged as the OHP sheet if the value is equal to or larger than the threshold Rt2. In the first management table 302, every time the printing is performed, the number of the plain paper is counted up if a value of reflected light detected by the media sensor 220 is smaller than the threshold Rt1. The number of the coat paper is counted up if the value is equal to or larger than the threshold Rt1 and smaller than the threshold Rt2. The number of the OHP sheets is counted up if the value is equal to or larger than the threshold Rt2.

FIG. 8 is a diagram of the structure example of the second management table 303.

As explained above, the second management table 303 stores, as statistic information, information concerning the thickness of the sheet P subjected to the printing in the digital multi-function peripheral 1. The media sensor 220 detects the thickness of the sheet P on the basis of light transmitted through the sheet P. In the second management table 303 shown in FIG. 8, as types of the sheet P having different thicknesses, thin paper, plain paper, and thick paper are assumed.

In the second management table 303 shown in FIG. 8, counted numbers of the sheets P judged as the thin paper, the sheets P judged as the plain paper, and the sheets P judged as the thick paper are stored. Concerning the thickness of the sheet P, the sheet P is judged as the thick paper if a value of a signal detected by the media sensor 220 from light transmitted through the sheet P is smaller than a threshold Tt1. The sheet P is judged as the plain paper if the value is equal to or larger than the threshold Tt1 and smaller than a threshold Tt2. The sheet P is judged as the thin paper if the value is equal to or larger than the threshold Tt2. In the second management table 303, every time the printing is performed, the number of the thick paper is counted up if a value of transmissive light detected by the media sensor 220 is smaller than the threshold Tt1. The number of the plain paper is counted up if the value is equal to or larger than the threshold Tt1 and smaller than the threshold Tt2. The number of the thin paper is counted up if the value is equal to or larger than the threshold Tt2.

Processing performed when the digital multi-function peripheral 1 explained above undergoes remote diagnosis for an image is explained below.

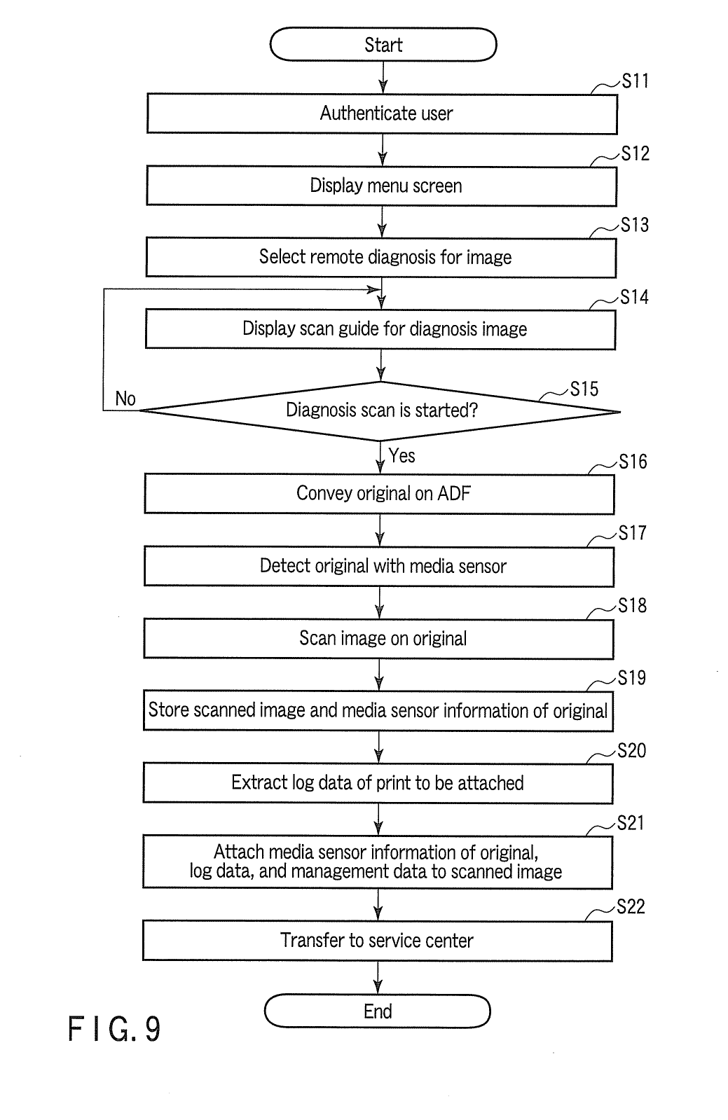

FIG. 9 is a flowchart for explaining a processing procedure in the digital multi-function peripheral 1 that undergoes remote diagnosis for an image.

For example, it is assumed that the user feels abnormality in an image printed on the sheet P by the digital multi-function peripheral 1. In such a case, the user can undergo remote diagnosis using the sheet P on which the image is printed in the digital multi-function peripheral 1. The remote diagnosis may be carried out according to operation by an administrator who receives a request from the user. In the following explanation, the user performs operation for undergoing the remote diagnosis.

The CPU 21 of the system control unit 10 of the digital multi-function peripheral 1 performs user authentication based on information that the user inputs using the control panel 14 (Act 11). The user authentication is performed on the basis of, for example, a user ID and a password inputted by the user. However, the user authentication may be performed according to another method using a storage medium or biological information. The user authentication in Act 11 may be omitted depending on an operation form of the digital multi-function peripheral 1.

If the user authentication is successful, the CPU 21 displays, on the display unit 141 on the control panel 14, a menu screen indicating processing items that the user can use (Act 12). In the control panel 14 in this state, remote diagnosis processing for an image can be selected. In this state, the user selects the remote diagnosis for an image (Act 13). The CPU 21 displays, on the display unit 141, a guide screen for scanning a diagnosis-object image (Act 14). The CPU 21 displays, on the display unit 141, a guide screen for urging the user to set, in the ADF 112, the sheet P (an original) on which the diagnosis-object image is printed. According to such a guidance, the user sets, in the ADF 112, the original on which the diagnosis-object image is printed and enters a start key for instructing the start of diagnosis scan.

If the key for instructing the start of the diagnosis scan is inputted (YES in Act 15), the CPU 21 instructs the scanner CPU 311 of the scanner 11 to perform diagnosis scan of the original set in the ADF 112. The scanner CPU 311 instructs conveyance of the original set in the ADF 112 (Act 16). If the original is conveyed, the media sensor 113 set in the ADF 112 detects, as characteristic information of the original, the information indicating a type of the original and the information indicating the thickness of the original explained above (Act 17). The information detected by the media sensor 113 is notified to the CPU 21 of the system control unit 10 via the scanner CPU 311. The CPU 21 temporarily stores the information detected by the media sensor 113 in the memory unit 22 as media sensor information of the original (Act 19).

In the scanner 11, the photoelectric conversion unit 312 scans the image on the original conveyed by the ADF 112 (Act 18). The photoelectric conversion unit 312 converts the optically-scanned image of the original into image data. The image data scanned by the scanner 11 is supplied to the system control unit 10 via the image processing unit 12 and the like. The CPU 21 of the system control unit 10 temporarily stores the image data scanned by the scanner 11 in the memory unit 22 (Act 19). The image data (image data for diagnosis) scanned by the scanner 11 is stored in the memory unit 22 in a state converted into a predetermined image format.

After storing the image data scanned by the scanner 11, the CPU 21 extracts, from the log database 301, log data that should be transmitted for the remote diagnosis for the image (Act 20). The CPU 21 may extract a predetermined number of log data or may extract log data that coincides with a specific condition. For example, the CPU 21 can output latest one hundred log data. The CPU 21 may extract log data of printing executed by the user specified by the user authentication. If information for specifying printing for an image that the user feels abnormal (e.g., a job number) is inputted, the CPU 21 may extract log data of the printing and log data immediately preceding the log data. This is because it is anticipated that an image printed immediately after printing is deteriorated because of a deficiency (fixing failure or transfer failure) in the immediately preceding printing.

If the log data that should be transmitted is extracted, the CPU 21 attaches the media sensor information of the original, the extracted log data, and the management data stored in the first and second management tables 302 and 303 to the image data for diagnosis stored in the memory unit 22 (Act 21). The CPU 21 transfers the data to the management PC 31 of the center system 6 set in the service center (Act 22). In an environment in which communication speed is low and transmission of image data is difficult, for example, the CPU 21 may transmit the data according to the method disclosed in JP-A-2005-20498.

The management PC 31 in the service center receives the data. An operator having specialized knowledge for performing diagnosis of an image performs image diagnosis. The operator can diagnose the image comprehensively referring to not only the scanned image data of the image that the user feels abnormal but also the setting information during the printing, the state of the sheet detected by the media sensor, detection information of the various sensors, and the statistic management data. In the processing explained above, not only the diagnosis-object image data (or the image data and the setting information) but also information concerning the sheet on which the image is printed can be transferred to the service center. Therefore, improvement of accuracy of image diagnosis can be expected. For example, if transfer failure or fixing failure occurs, since information concerning the sheet is obtained, it is possible to easily judge whether a state of the sheet is included in a cause of the deficiency.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a setting unit that sets setting information for forming an image on a recording medium;
a printer that forms an image on the recording medium on the basis of setting contents set by the setting unit;
a media sensor that detects characteristic information of the recording medium on which the printer forms an image;
a storing unit that stores, if the printer forms an image on the recording medium, as log data, the setting information set by the setting unit and the characteristic information of the recording medium detected by the media sensor; and
an interface that transmits the log data stored in the storing unit to an image diagnosis apparatus that diagnoses a state of image forming processing in the image forming apparatus.

2. The apparatus according to claim 1, further comprising a state sensor that detects a state when the printer forms an image on the recording medium, wherein
the storing unit further stores, as the log data, information indicating the state during the image formation detected by the state sensor.

3. The apparatus according to claim 2, wherein the state sensor is a humidity sensor that detects humidity in the printer, a temperature sensor that detects temperature in the printer, a potential sensor that detects surface potential of a photoconductive member for forming an electrostatic latent image in the printer, or a density sensor that detects density of an image transferred onto the recording medium.

4. The apparatus according to claim 1, further comprising a scanner that scans the image formed on the recording medium by the printer and converts the image into image data, wherein
the communication interface transmits the log data to be stored in the storing unit to the image diagnosis apparatus together with the image data scanned from the recording medium by the scanner.

5. The apparatus according to claim 4, further comprising an extracting unit that extracts, from the storing unit, as the log data that should be transmitted to the image diagnosis apparatus, log data obtained when the image scanned by the scanner is formed on the recording medium, wherein
the communication interface transmits the log data extracted by the extracting unit to the image diagnosis apparatus together with the image data scanned from the recording medium by the scanner.

6. The apparatus according to claim 5, wherein the extracting unit extracts, from the storing unit, log data including the log data obtained when the image scanned by the scanner is formed on the recording medium and log data immediately preceding the log data.

7. The apparatus according to claim 1, further comprising:
a classifying unit that classifies the recording medium on the basis of the characteristic information detected by the media sensor; and
a management table that accumulates data indicating a result of the classification by the classifying unit, wherein
the communication interface further transmits the data accumulated in the management table to the image diagnosis apparatus together with the image data scanned from the recording medium by the scanner.

8. The apparatus according to claim 7, wherein
the classifying unit classifies the recording medium according to a surface state estimated on the basis of information obtained by detecting reflected light from a surface of the recording medium with the media sensor, and
the management table accumulates data indicating a result of the classification based on the surface state of the recording medium by the classifying unit.

9. The apparatus according to claim 7, wherein
the classifying unit classifies the recording medium according to thickness estimated on the basis of information obtained by detecting transmissive light transmitted through the recording medium with the media sensor, and
the management table accumulates data indicating a result of the classification based on the thickness of the recording medium by the classifying unit.

10. The apparatus according to claim 1, further comprising:
an authenticating unit that performs user authentication; and
an extracting unit that extracts, from the storing unit, log data including user information indicating a user for whom authentication by the authenticating unit is successful, wherein
the printer forms an image on the recording medium if the user authentication by the authenticating unit is successful,
the storing unit stores the log data including the user information indicating the user for whom the authentication by the authenticating unit is successful, and
the communication interface transmits the log data including the user information indicating the user for whom the authentication by the authenticating unit is successful, which is extracted by the extracting unit, to the image diagnosis apparatus together with the image data scanned from the recording medium by the scanner.

11. The apparatus according to claim 10, wherein
the extracting unit extracts the log data including the user information indicating the user for whom the authentication by the authenticating unit is successful and log data immediately preceding the log data including the user information, and
the communication interface transmits the log data extracted by the extracting unit to the image diagnosis apparatus together with the image data scanned from the recording medium by the scanner.

12. The apparatus according to claim 4, further comprising a second media sensor that detects characteristic information of the recording medium from which the scanner scans the image, wherein the communication interface further transmits the characteristic information of the recording medium detected by the second media sensor.

13. An image scanning apparatus comprising:
a scanner that scans an image formed on a recording medium by a printer and converts the image into image data;
a media sensor that detects characteristic information of the recording medium; and
a communication interface that transmits the image data scanned from the recording medium by the scanner and the characteristic information of the recording medium detected by the media sensor to an image diagnosis apparatus that diagnoses the image formed on the recording medium by the printer.

14. A remote diagnosis method for an image forming apparatus, the remote diagnosis method comprising:
setting information for forming an image;
detecting, using a media sensor, characteristic information of a recording medium on which an image is formed according to setting by the setting information;
forming an image on the recording medium, the characteristic information of which is detected by the media sensor, on the basis of the setting information;
storing, as log data, the setting information for forming an image on the recording medium and the characteristic information of the recording medium detected by the media sensor; and
transmitting the log data to an image diagnosis apparatus that diagnoses a state of image forming processing in the image forming apparatus.

15. The method according to claim 14, further comprising detecting a state when an image is formed on the recording medium, wherein
the storing is further storing, as the log data, information indicating the detected state during the image formation.

16. The method according to claim 15, wherein the detecting the state is detecting humidity in the image forming apparatus, temperature in the image forming apparatus, surface potential of a photoconductive member for forming an electrostatic latent image in the image forming apparatus, or density of an image transferred onto the recording medium.

17. The method according to claim 14, further comprising scanning the image formed on the recording medium and converting the image into image data, wherein
the transmitting is transmitting the log data together with the image data scanned from the recording medium.

18. The method according to claim 17, further comprising extracting, from the stored log data, as the log data that should be transmitted to the image diagnosis apparatus, log data obtained when the image to be converted into the image data is formed on the recording medium, wherein
the transmitting is transmitting the extracted log data to the image diagnosis apparatus together with the image data scanned from the recording medium.

19. The method according to claim 18, wherein the extracting is extracting, from the stored log data, the log data obtained when the image to be converted into the image data is formed on the recording medium and log data immediately preceding the log data as log data that should be transmitted to the image diagnosis apparatus.

20. The method according to claim 14, further comprising:
classifying the recording medium on the basis of the characteristic information detected by the media sensor; and
accumulating data indicating a result of the classification by the classifying in a management table, wherein
the transmitting is further transmitting the data accumulated in the management table to the image diagnosis apparatus together with the image data scanned from the recording medium.

21. The method according to claim 20, wherein
the classifying is classifying the recording medium according to a surface state estimated on the basis of information obtained by detecting reflected light from a surface of the recording medium with the media sensor, and
data indicating a result of the classification based on the surface state of the recording medium by the classifying is accumulated in the management table.

22. The method according to claim 20, wherein
the classifying is classifying the recording medium according to thickness estimated on the basis of information obtained by detecting transmissive light transmitted through the recording medium with the media sensor, and
data indicating a result of the classification based on the thickness of the recording medium by the classifying is accumulated in the management table.

23. The method according to claim 14, further comprising:
authenticating a user; and
extracting, from the stored log data, log data including user information indicating a user for whom authentication is successful, wherein
the forming an image is forming an image on the recording medium if the authentication is successful,
the storing is storing the log data including the user information indicating the user for whom the authentication is successful, and
the transmitting is transmitting the log data including the user information indicating the user for whom the authentication is successful to the image diagnosis apparatus together with the image data scanned from the recording medium.

24. The method according to claim 23, wherein
the extracting is extracting the log data including the user information indicating the user for whom the authentication is successful and log data immediately preceding the log data including the user information, and
the transmitting is transmitting the extracted log data to the image diagnosis apparatus together with the image data scanned from the recording medium.

25. The method according to claim 17, further comprising detecting, with a second media sensor, characteristic information of the recording medium from which the image is scanned, wherein
the transmitting further transmitting the characteristic information of the recording medium detected by the second media sensor.
